(19) United States
(12) Patent Application Publication
(10) Pub. No.: US 2009/0079814 A1
(43) Pub. Date: Mar. 26, 2009

(54) Video conference video signal switching

(75) Inventor: David Hsu, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: C&C TECHNIC TAIWAN CO., LTD., Taipei Hsien (TW)

(21) Appl. No.: 11/902,375

(22) Filed: Sep. 21, 2007

(51) Int. Cl. H04N 7/14

(52) U.S. Cl. 348/14.08; 348/E07.083

(57) ABSTRACT

A video conference video signal switching system is disclosed to include a local signal-transmitting side comprised of a video signal transmitter receiver unit and a selection control and power converter unit for allowing the user to switch 8 different input video signals for output, a remote signal-receiving side comprised of a 1˜8 channels video signal selector unit, a 1˜8 channels detection and local power supply unit, a microprocessor, and a video signal output unit, and a category-5 or category-6 network cable connected between the local signal-transmitting side and the remote signal-receiving side. By means of the control of the microprocessor, the user can selectively switch 8 different input video signals received from the local signal-transmitting side for output to an external display monitor via the video signal output unit.

### BACKGROUND OF THE INVENTION

1. Field of the Invention

The present invention relates to a video conference video signal switching system and more particularly, to such a video conference video signal switching system, which uses a category-5 or category-6 network cable to substitute for a VGA cable for connection between the local signal-transmitting side and the remote signal-receiving side to facilitate wiring inside the wall and to improve the video signal transmission quality.

2. Description of the Related Art

Regular video signaling devices commonly use standard VGA (video graphics array) cables to connect computers and switches. The use of standard VGA cables has a distance limitation. When used for a long distance, the video signal transmission quality will become poor. Further, a VGA cable uses a big connector, complicating its wiring inside the wall. Further, a common infrared remote control or manual video signal switch is used for different people to select different video signals from different channels. When using the infrared remote control or manual video signal switch, the user must accurately select the desired channel, preventing an error.

### SUMMARY OF THE INVENTION

The present invention has been accomplished under the circumstances in view. It is the main object of the present invention to provide a video conference video signal switching system, which facilitates wiring inside the wall and improves the video transmission quality.

To achieve this and other objects of the present invention, the video conference video signal switching system comprises a local signal-transmitting side, and a remote signal-receiving side. The local signal-transmitting side comprises a video signal transmitter receiver unit electrically connected to video signal source means for video signal input, and a selection control and power converter unit electrically connected to the video signal transmitter receiver unit for allowing the user to switch 8 different video signals for output. The remote signal-receiving side comprises a 1˜8 channels video signal selector unit coupled to the selection control and power converter unit of the local signal-transmitting side through a category-5 or category-6 network cable, a 1˜8 channels detection and local power supply unit electrically connected in parallel to the 1˜8 channels video signal selector unit for receiving signal from the local signal-transmitting side, a microprocessor electrically coupled to the 1˜8 channels video signal selector unit and the 1˜8 channels detection and local power supply unit for allowing switching of 8 video signals received from the local signal-transmitting side, and a video signal output unit electrically coupled to the 1˜8 channels detection and local power supply unit for signal output to an external display monitor.

### BRIEF DESCRIPTION OF THE DRAWINGS

FIG. 1 is a circuit block diagram of a local signal-transmitting side of a video conference video signal switching system according to the present invention.

FIG. 2 is a circuit block diagram of a remote signal-receiving side of the video conference video signal switching system according to the present invention.

FIG. 3 is a circuit block diagram showing an application example of the present invention.

### DETAILED DESCRIPTION OF THE PREFERRED EMBODIMENT

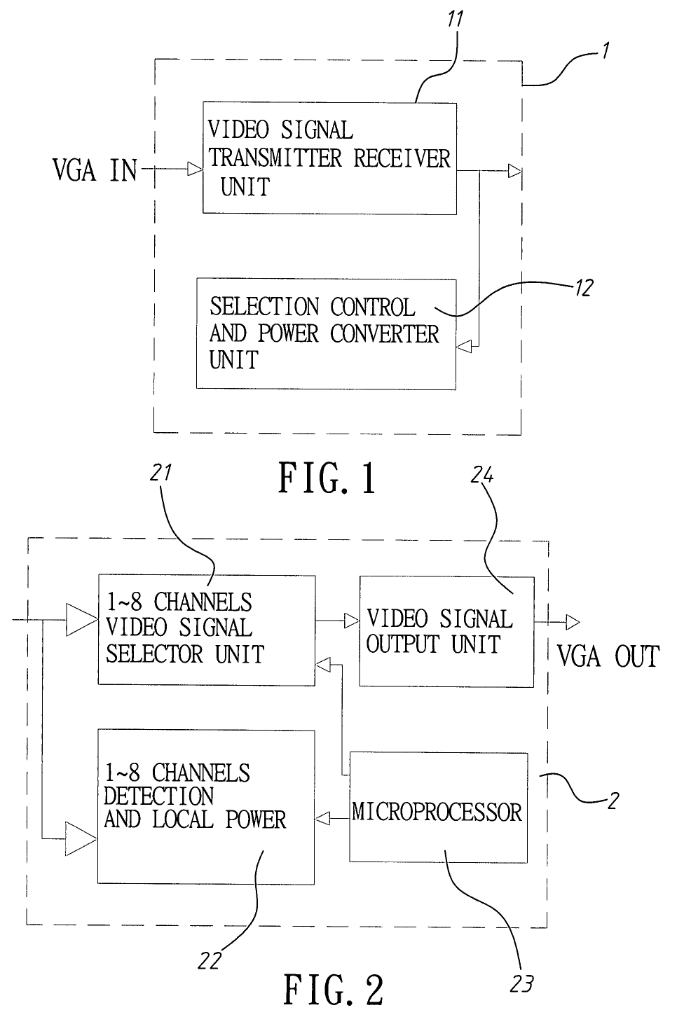

Referring to FIGS. 1 and 2, a video conference video signal switching system comprises a local signal-transmitting side 1 and a remote signal-receiving side 2.

The local signal-transmitting side 1 comprises a video signal transmitter receiver unit 11 for VGA (Video Graphics Array) signal input, and a selection control and power converter unit 12 electrically connected to the video signal transmitter receiver unit 11.

The remote signal-receiving side 2 comprises a 1˜8 channels video signal selector unit 21, a 1˜8 channels detection and local power supply unit 22 electrically connected in parallel to the 1˜8 channels video signal selector unit 21 for receiving signal from the local signal-transmitting side 1, a microprocessor 23 electrically coupled to the 1˜8 channels video signal selector unit 21 and the 1˜8 channels detection and local power supply unit 22, and a video signal output unit 24 electrically coupled to the 1˜8 channels detection and local power supply unit 22.

When in use, the remote signal-receiving side 2 is electrically connected to the local signal-transmitting side 1 by a category-5 or category-6 cable, and the video signal transmitter receiver unit 11 is coupled to a video signal source for video input. The selection control and power converter unit 12 allows the user to switch 8 different video signals from different channels. When a video signal is transmitted from the local signal-transmitting side 1 into the remote signal-receiving side 2, it is controlled by the microprocessor 23 for allowing switching of 8 video signals by the user. The use of a category-5 or category-6 cable to substitute for a VGA cable for connection between local signal-transmitting side 1 into the remote signal-receiving side 2 facilitates wiring inside the wall and improves video transmission quality.

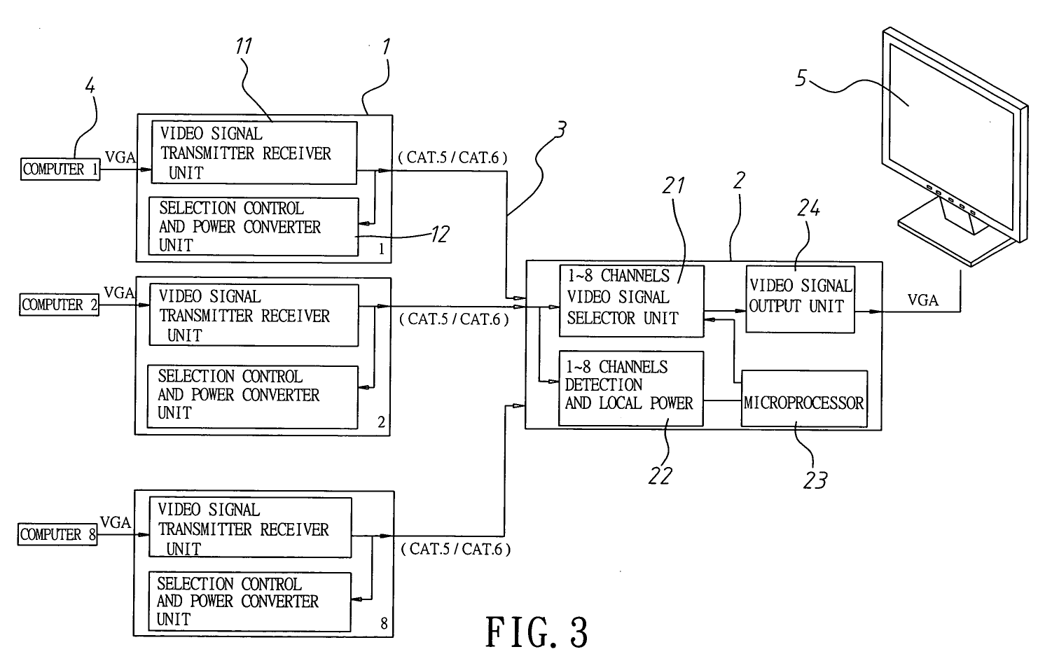

Referring to FIG. 3, 8 local signal-transmitting sides 1 are respectively connected to the remote signal-receiving side 2 by a respective category-5 or category-6 cable 3, and the video signal transmitter receiver units 11 of the 8 local signal-transmitting sides 1 are respectively connected to respective computers 4 for video signal input from the associating computers 4. After signal input, the selection control and power converter unit 12 of each local signal-transmitting sides 1 allows switching of 8 different video signals by the user, enabling the video signals to be transmitted to the remote signal-receiving side 2 through the respective category-5 or category-6 cables 3. Subject to the control of the microprocessor 23, the remote signal-receiving side 2 allows for switching of 8 video signals for output through the video signal output unit 24 to a display monitor 5 for display.

As stated above, the invention uses a category-5 or category-6 cable to substitute for a standard VGA cable for connection between each local signal-transmitting side 1 and the remote signal-receiving side 2, facilitating wiring inside the wall and improving video transmission quality.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A video conference video signal switching system, comprising:
a local signal-transmitting side, said local signal-transmitting side comprising a video signal transmitter receiver unit electrically connected to video signal source means for video signal input and a selection control and power converter unit electrically connected to said video signal transmitter receiver unit for allowing the user to switch 8 different video signals for output; and
a remote signal-receiving side, said remote signal-receiving side comprising a 1˜8 channels video signal selector unit coupled to said selection control and power converter unit of said local signal-transmitting side through a cable thereof, a 1˜8 channels detection and local power supply unit electrically connected in parallel to said 1˜8 channels video signal selector unit for receiving signal from said local signal-transmitting side, a microprocessor electrically coupled to said 1˜8 channels video signal selector unit and said 1˜8 channels detection and local power supply unit for allowing switching of 8 video signals received from said local signal-transmitting side, and a video signal output unit electrically coupled to said 1˜8 channels detection and local power supply unit for signal output to an external display monitor.

2. The video conference video signal switching system as claimed in claim 1, wherein said cable is a category-5 network cable.

3. The video conference video signal switching system as claimed in claim 1, wherein said cable is a category-6 network cable.
